(19) United States
(12) Patent Application Publication
(10) Pub. No.: US 2012/0198067 A1
(43) Pub. Date: Aug. 2, 2012

(54) MECHANISM FOR FACILITATING INTEGRATION OF CUSTOMER RELATIONSHIP MANAGEMENT SERVICES AND NON-CUSTOMER RELATIONSHIP MANAGEMENT SERVICES VIA AN INTEGRATED SERVICES MECHANISM

(75) Inventors: STEVEN KENNETH WEISS, Foster City, CA (US); Thomas Charles Dvornik, San Francisco, CA (US); Michael Quoc Luu, San Francisco, CA (US)

(73) Assignee: SALESFORCE.COM, INC., SAN FRANCISCO, CA (US)

(21) Appl. No.: 13/077,662

(22) Filed: Mar. 31, 2011

Related U.S. Application Data
(60) Provisional application No. 61/437,312, filed on Jan. 28, 2011.

(51) Int. Cl. G06F 15/173

(52) U.S. Cl. 709/226

(57) ABSTRACT

In accordance with embodiments, there are provided methods and systems for facilitating integration of customer relationship management (CRM) services and non-CRM services into a single integrated services mechanism. A method of embodiments includes integrating CRM modules to provide access to CRM services with non-CRM modules to provide access to non-CRM services into a single integrated mechanism. The integrated mechanism may be employed at a first computing system. The method may further include processing a user request for one or more services. The one or more services include one or more CRM services or one or more non-CRM services. The method may further include providing access to the one or more services via the integrated mechanism at the first computing system.

### CLAIM OF PRIORITY

This application claims the benefit of U.S. Provisional Patent Application No. 61/437,312, entitled “Systems and Methods for Mobile CRM” by Steve Weiss, et al., filed Jan. 28, 2011 (Attorney Docket No. 8956P048Z), the entire contents of which are incorporated herein by reference and priority is claimed thereof.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. Technical Field

One or more implementations relate generally to customer relationship management (CRM) and, more specifically, to a mechanism for facilitating integration of CRM services and non-CRM services via an integrated services mechanism in a database network system.

2. Background

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

CRM refers to services for managing an organization's interactions with its customers, potential customers, business partners, etc., while organizing and synchronizing various business processes, such as sales activities, technical support, etc. Typically, CRM services are provided as large software applications and tools and are suitable to be accessed on large computing devices with significant computing resources, such as desktop computers, laptop computers, and the like, which makes it difficult for those users (e.g., plumbers, electricians, etc.) that work or conduct business away from their offices (e.g., in the field). Further, CRM services are provided separate from other essential services (e.g., telephony), which requires users to seek those services from other third-party vendors. This is not only inefficient, but also significantly raises the cost of employing CRM and other services, particularly for small- and medium-sized businesses with relatively small spending budgets.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The efficient retrieval of accurate information and subsequent delivery of this information to the user system has been and continues to be a goal of administrators of database systems. Unfortunately, conventional database approaches might become inefficient if, for example, the relationship (between various software entities) is relatively complex (and expensive). Accordingly, it is desirable to provide techniques enabling efficient and convenient access to various software entities of the database system, and/or to provide them less expensively to improve efficiency and the ease of use of the database system.

### SUMMARY

In accordance with embodiments, there are provided methods and systems for facilitating integration of CRM services and non-CRM services into a single integrated services mechanism. A method of embodiments includes integrating CRM modules to provide access to CRM services with non-CRM modules to provide access to non-CRM services into a single integrated services mechanism. The integrated services mechanism may be employed at a first computing system. The method may further include processing a user request for one or more services. The one or more services include one or more CRM services or one or more non-CRM services. The method may further include providing access to the one or more services via the integrated services mechanism at the first computing system.

While the present invention is described with reference to an embodiment in which techniques for facilitating integration of CRM and non-CRM services into an integration services mechanism in a network environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. One or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a computing system employing an integrated services mechanism according to one embodiment;

FIG. 2 illustrates an integrated services mechanism according to one embodiment;

FIG. 3 illustrates a method for facilitating integration of CRM services and non-CRM services via an integrated services mechanism according to one embodiment;

FIGS. 4A-4B illustrate screenshots representing various processes for facilitating integration of CRM services and non-CRM services via an integrated services mechanism according to one embodiment;

FIG. 5 illustrates a computer system according to one embodiment;

FIG. 6 illustrates a block diagram of an environment wherein an on-demand database service might be used according to one embodiment; and

FIG. 7 illustrates a block diagram of an embodiment of elements of environment of FIG. 6 and various possible interconnections between these elements according to one embodiment.

### DETAILED DESCRIPTION

Methods and systems are provided for facilitating integration of CRM services and non-CRM services via an integrated services mechanism in a database network system. Embodiments provide for integration of CRM services with other essential non-CRM user services (e.g., telephony services, social networks, etc.) into a single integrated services mechanism which is capable of being provided on mobile devices in a network environment.

This integrated services mechanism is provided much lower in cost (compared to a conventional non-integrated, non-mobile CRM mechanism) and can be operated using minimal resources (such as those employed by mobile computing devices) while, in one embodiment, it remains scalable to larger computing machines, such as desktop or laptop computers. This “lightweight” integrated services mechanism is capable of providing CRM services on mobile devices, which is particularly useful to those users who are cost-prohibitive, such as owners of small- or medium-sized businesses, and/or those use who primarily use mobile devices. This way, users (e.g., plumbers, electricians, interior designers, etc.) who, for example, have smaller spending budgets and/or typically work outside their offices (e.g., in the field, in customers' homes, etc.) can have readier access to CRM and other services on their mobile devices without losing any of the benefits or essential elements of a non-integrated, non-mobile CRM mechanism and other essential mechanism and services.

Furthermore, in one embodiment, since the both the CRM services and non-CRM services are provided through a single integrated services mechanism, the users (e.g., business owners/managers/employees) do not have to shop several third-party vendors to complete their network or puzzle of services they require to run their businesses. Thus, employing and using the novel integrated services mechanism is far more efficient both in terms of cost and labor for businesses (particularly, small businesses) than using the conventional method of shopping for each service separately.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods are provided for facilitating a single integrated services mechanism in a network environment.

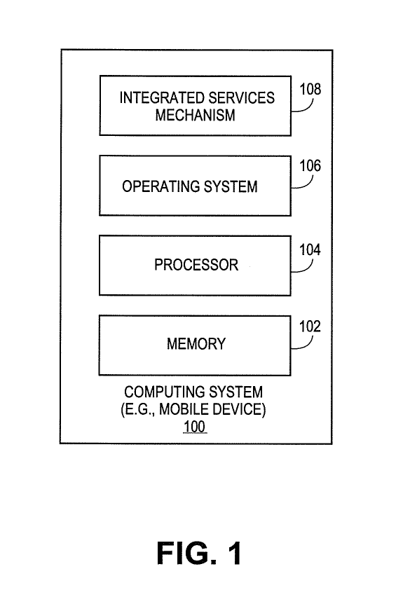

FIG. 1 illustrates a computing system 100 employing an integrated services mechanism 108 according to one embodiment. Computing system 100 (e.g., mobile computing device, such as a smartphone, a handheld computer, a tablet computer, etc.) comprises a base hardware/software platform, which may be capable, for example, of working with a standard operating system 106. Operating system 106 serves as an interface between any hardware or physical resources of the computing system 100 and a user. In some embodiments, the base platform may further include processors 104, memory devices 102, network devices, drivers, and so on. Computing system 100 may include a computing device (e.g., a mobile device, a desktop computer, a laptop computer, etc.) serving as a client computing system while, in some embodiments, computing system 100 may serve as a server computing system. It is to be noted that terms like “machine”, “device”, “computer”, “computing device”, and “computing system” are used interchangeably and synonymously throughout this document.

In one embodiment, computing system 100 employs the integrated services mechanism 108 (“integrated mechanism”) to provide CRM services (also herein referred to as “CRM functionalities”, “CRM processes”, “CRM offerings”, etc.) integrated with other essential user non-CRM services (also referred to as “non-CRM functionalities”, “non-CRM processes”, “non-CRM offerings”, etc.), such as telephony services (e.g., telephone, voicemail, short message service (SMS), etc.), email services including direct access to company email and public email services (e.g., Google® Gmail®, Microsoft® Hotmail®, etc.), Internet access including easy access to social networks (e.g., Facebook®, Twitter®, etc.) and other useful websites (e.g., yelp®, Where®, Google Earth®, Google Maps®, etc.), customer service, etc.

In one embodiment, the integrated mechanism 108 includes a CRM software application and other non-CRM services applications that are employed (e.g., downloaded, installed, etc.) on computing devices 100, such as a mobile computing device to allow users to access the integrated services through their mobile device. For example and in one embodiment, a user may install the integrated mechanism 108 on a computing device 100 from one of several digital distribution platforms for mobile devices, such as the Apple® App Store™ for iOS™ devices, the Android™ Marketplace for Android™ OS devices, and the like. Once the integrated mechanism 108 has been downloaded on a computing system 100, such as a mobile device, the user may simply register (e.g., create a profile, username, password, etc.) and access the integrated services (e.g., CRM and non-CRM services) using the mobile device employing the integrated mechanism 108 without having to access a desktop or a laptop or other large and fixed computing devices.

However, in one embodiment, the integrated mechanism 108 is scalable to other computing devices and thus, a user is not limited to using the integrated mechanism 108 only through a mobile device, but may choose to access the various services provided by the integrated mechanism 108 using other computing systems, such as desktop or laptop computers. In yet another embodiment, the integrated mechanism 108 may include one or more portals and/or one or more Application Programming Interfaces (“APIs” or simply ‘interfaces“) to provide, via the computing system 100, access or link to a non-integrated, non-mobile CRM mechanism and other services that may reside at another machine, such as a server computing system over a network (e.g., Internet), a cloud-based machine to be accessed through cloud computing or a cloud network, a remote desktop or laptop machine at home or in the office through Virtual Private Network (VPN), etc. The integrated mechanism 108 further provides an appropriate display through a user interface to the user so that the user may access and view the CRM and non-CRM services.

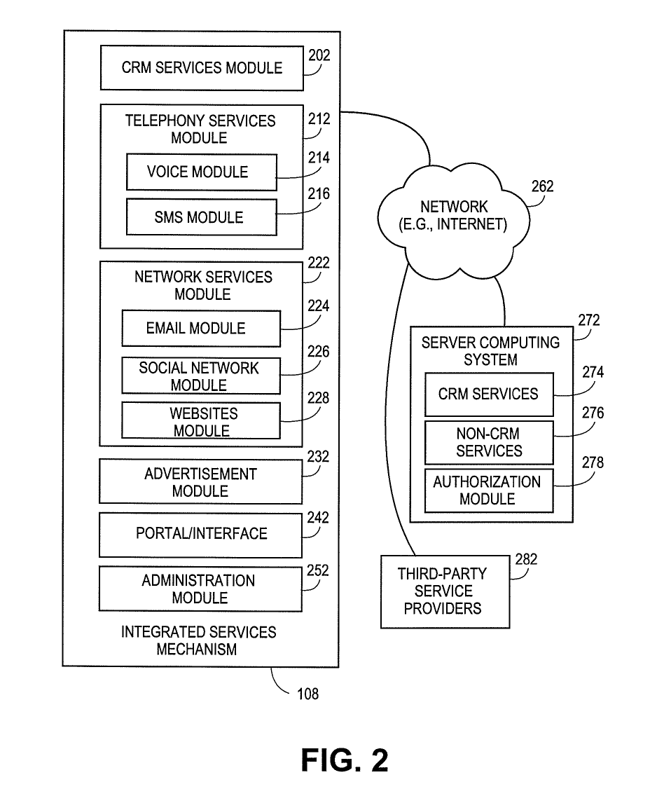

FIG. 2 illustrates an integrated services mechanism 108 according to one embodiment. In one embodiment, the integrated mechanism 108 integrates a number of services, such as CRM services, telephone services, etc. As illustrated, the integrated mechanism 108 includes a CRM service module 202 to provide CRM services for managing and promoting a company's business and relations with its customers and potential customers, such as to gain new clients and retain the existing ones. Essentially, CRM services provide a customer relation management that uses the current technology and available information to organize, automate, and synchronize various business processes, such as sales activities, etc., to gain new customers and manage existing customers with high quality, greater efficiency, decreased costs, etc.

In on embodiment, these CRM services that are provided through the CRM services module 202 are integrated with a number of other services that are provided through their corresponding modules 212, 222, 232, 242, 252. For example, telephony services module 212 provide various telephone services, such as voice services through a voice module 214, SMS services through an SMS module 216, etc. Having telephone services integrated with CRM services prevents the user (e.g., a small business owner) from going to or hiring a third-party service provider (e.g., a telephone company) to provide telephone services. The voice module 214, in one embodiment, may be configured to work with other text-based modules, such as the SMS module 216 and the email module 224, to convert the text (e.g., an email) into voice and vice versa for the user, if desired or necessitated. For example, a user can perform certain settings on a mobile computing device such that the voice module 214 is configured to automatically translate text into voice. Now, for example, if a user receives an email, while driving, the voice module 214 may automatically translate the email message into a voice message so that the user may listen to it without having to navigate the computing device to read the email message. Conversely, for example, in a meeting the voice module 214 may convert an incoming voicemail message into a text or email message for the user to read.

Integrated mechanism 108 further includes network services module 222 to provide access to network and network-related entities, such as email through the email module 224, social networks through a social network module 226, other essential websites using a website module 228, and the like. Email may include a company-based email (e.g., employeename@company-name.com) as well as a quick access to various public email websites (e.g., Hotmail, Gmail, etc.). Similarly, easy access (such a button) may be provided to reach various social network websites (e.g., Facebook®, Twitter®, Buzz®, etc.) using the social network module 226. Other essential websites (e.g., yelp, Google maps, weather websites, news websites, etc.) may be provided through the websites module 228.

Integrated mechanism 108 may further include an advertisement module 232 to provide targeted advertisement to the user based on the user information collected through a user profile generated during registration and/or from tracking the nature of user's business, interests, etc., such as from the user's use of various websites, etc. In one embodiment, advertisement module 232 as well as other modules, like the CRM services module 202, telephony services module 212, network services module 222, administration module 252, etc., work and stay in communication with a server computing system 272 employing CRM and other non-CRM services 274, 276. For example, each time a user requests a service (e.g., a CRM service, a website, an email, etc.), the corresponding module, such as the CRM service module 202 (if a CRM service is requested) accesses the CRM services 274 at the server computing system 272 via the portal/interface 242, over a network 262 (e.g., Internet), to receive the requested CRM service.

Similarly, in one embodiment, when a user requests a non-CRM service, such as a social network website, etc., the network service module 222 and its social network module 226 may, via the portal/interface 242 and over the network 262, access the non-CRM services 276 of the server computing system 272 to receive the requested social network website. These requested CRM and non-CRM services, although received from the server computing system 272, are then provided to the user via the user's computing device, such as a smartphone. In another embodiment, the network services module 222 may access a third-party service provider 282 to receive the requested non-CRM service which is then displayed to the user on the user's computing device. Similarly, other modules, like the telephony service module 212, may be set up to receive the telephone services directly from the third-party service provider 282 or the server computing system 272 over the network 262. In another embodiment, the portal/interface 242 may be used to provide a client computing device direct access to or portal into the server computing system 272. For example, the user, using a mobile computing device, may access the CRM services 274 directly from a non-integrated, non-mobile CRM mechanism employed at the server computing system 272.

In one embodiment, the user may be provided the aforementioned CRM and non-CRM services by the integrated mechanism 108 after the user has signed up or registered using a client computing device (e.g., mobile device). For example, a user may be asked to set up a short personal or business profile including a username and a password for future logins. This information is recorded and recognized at the server computing system 272 using an authorization module 278. Thereafter, each time the user logs into the integrated mechanism 108 at the client computing system, the user is recognized and authorized by the authorization module 278 at the server computing system 272 to allow the user to access the various CRM and non-CRM services provided by the integrated mechanism 108.

Further, in one embodiment, an administration module 252 may be provided for the user (e.g., a supervisor at or an owner of a business organization) to customize the CRM and non-CRM services provided by the integrated mechanism 108 for other users (e.g., employees at the business organization) at the business organization. For example, a high-level sales supervisor may have access to the entire customer/sales database while a low-level sales employee for a particular product or region may have access to only a section of the customer/sales database relating to that particular product or region. The administration module 252 may be used to perform any number of tasks, such as creating email accounts, changing passwords, adding new modules to or removing existing modules from the integrated mechanism 108, etc., to efficiently customize and configure the integrated mechanism 108 according to the capacity, needs, and goals of the business organization.

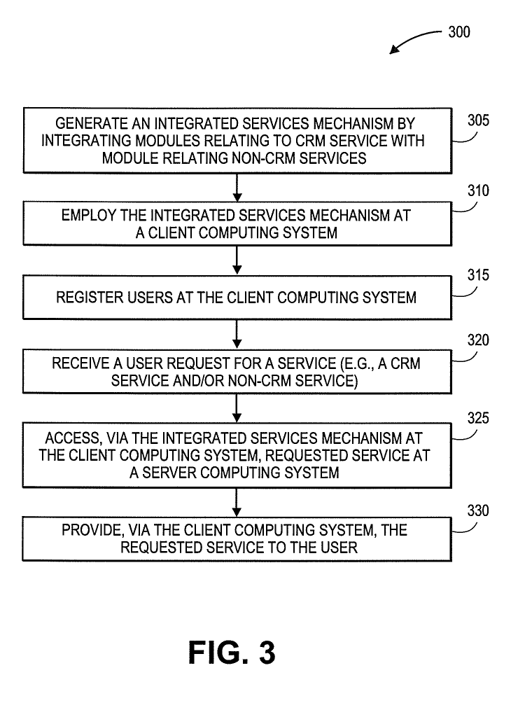

FIG. 3 illustrates a method 300 for facilitating integration of CRM services and non-CRM services via an integrated services mechanism according to one embodiment. Method 300 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 300 is performed by the integrated services mechanism 108 of FIGS. 1.

Method 300 begins with generating the integrated services mechanism by integrating CRM services with non-CRM services at block 305. In one embodiment, this integration of services includes combining modules associated with CRM services with modules associated with non-CRM services within a single integrated mechanism that can be installed or downloaded on a single computing system, such as a client-side mobile computing device. At block 310, the integrated mechanism is employed on a client computing system. At block 315, users are registered on the client computing system by having each user create a user profile along with a username and a password. The registration may be acknowledged and authorized at a server computing system that is in communication with the client computing system over a network (e.g., Internet).

At block 320, a user request for a service (e.g., a CRM service or a non-CRM service) is received and processed at the client computing system. In one embodiment, at block 325, in response to the user request, the integrated mechanism at the client computing system accesses the requested service (e.g., a CRM service) at the server computing system. The server computing system verifies and authorizes any combination of the user, the user profile, the user request, and the client computing system prior to providing access to the requested service or information relating it. Once the verification is performed, the server computing system satisfies the request by providing to the client computing system to the requested service (and/or the information relating to it). In another embodiment, a requested non-CRM service (e.g., a social network website) may be obtained from directly a third-party provider. At block 330, the integrated mechanism provides the user access to the requested service via the client computing system. For example, in one embodiment, in response to a user CRM request for a list of potential clients or a non-CRM request for a social network website (e.g., LinkedIn®), the integrated mechanism contacts the server computing system and, in return, provides access to the list of potential clients and the requested social network website to the user via the client computing system. In another embodiment, the list of potential clients may be provided by the server computing system, while access to the social network website may be provided by a third-party entity. Either way, the user receives access to the requested CRM and non-CRM services at the client computing system, such as a mobile device, without having to access another computing device, such as a desktop, etc.

However, as aforementioned, the integrated mechanism is scalable to large and fixed computing systems and this can be accomplished by simply (re)configuring the integrated mechanism using the administration module. For example, in a small business environment, some employees (e.g., those that typically work in their offices and/or lower-grade employees) of a business organization may be given access to the integrated mechanism via their desktop computers in their offices, while other employees (e.g., those that typically work out in the field and/or upper-grade employees) may be given access to the integrated mechanism via their mobile devices (e.g., Blackberry®, iPhone®, etc.).

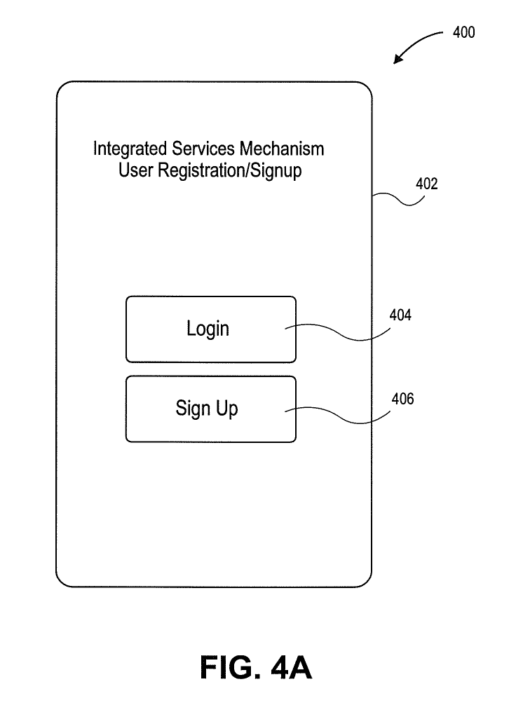

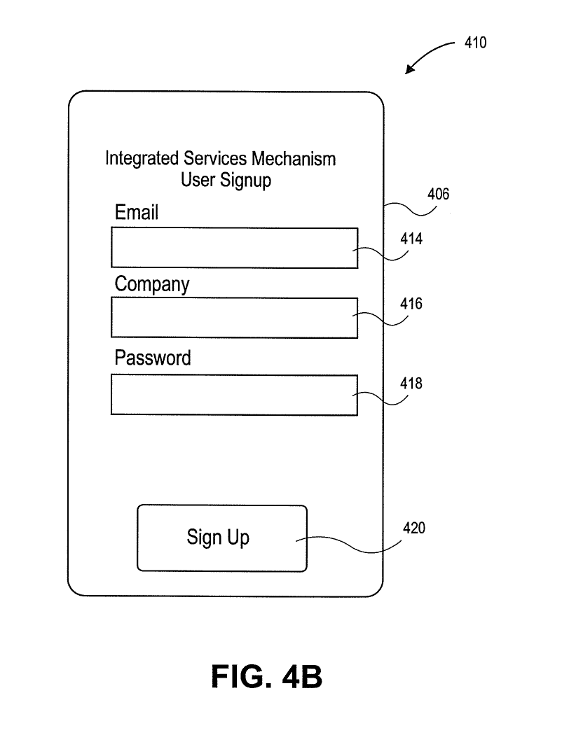

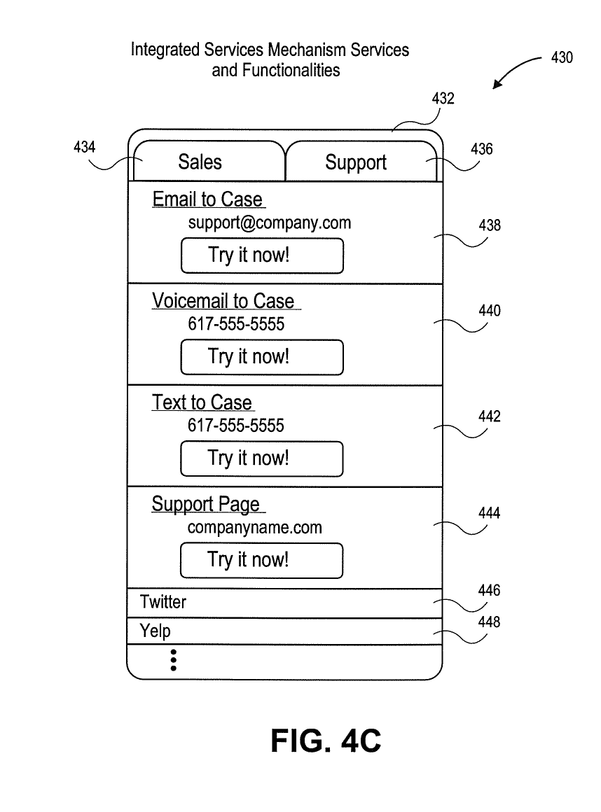

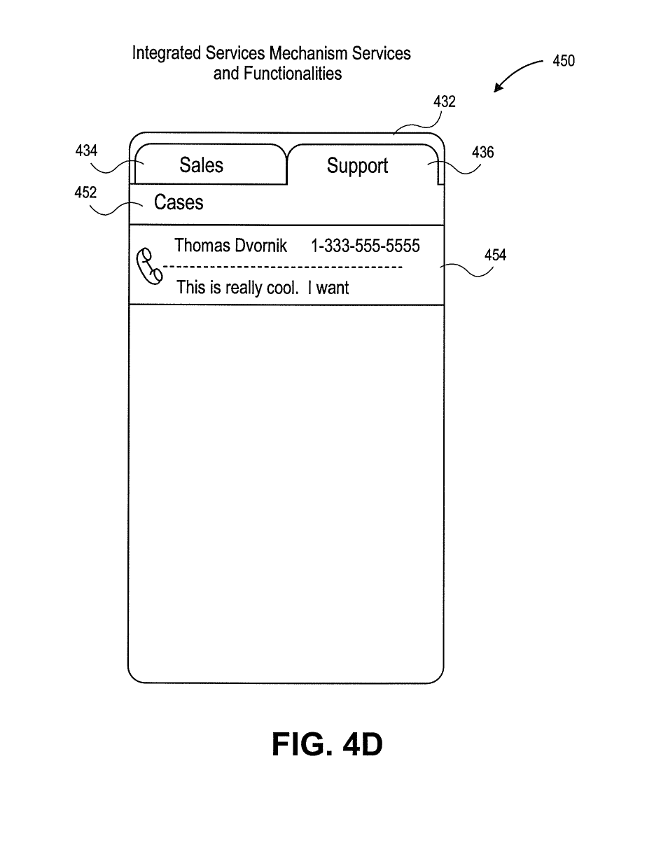

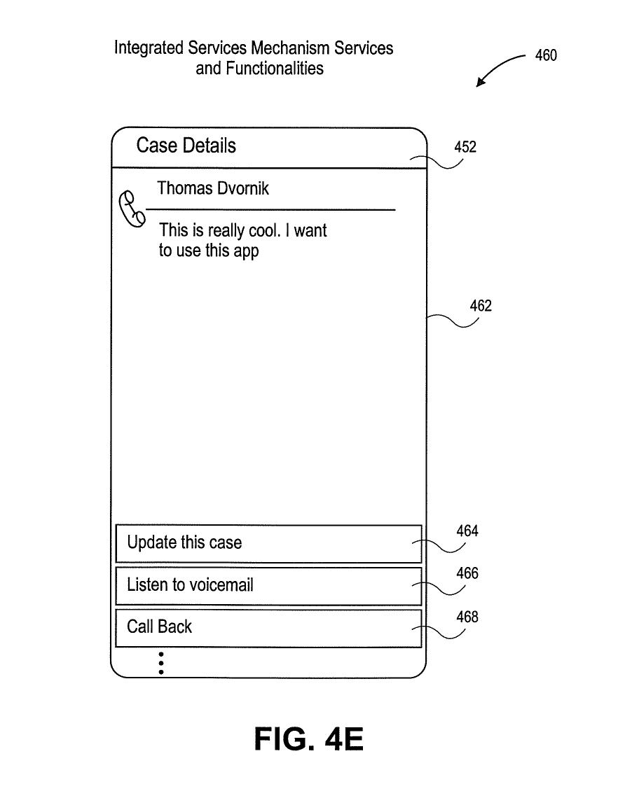

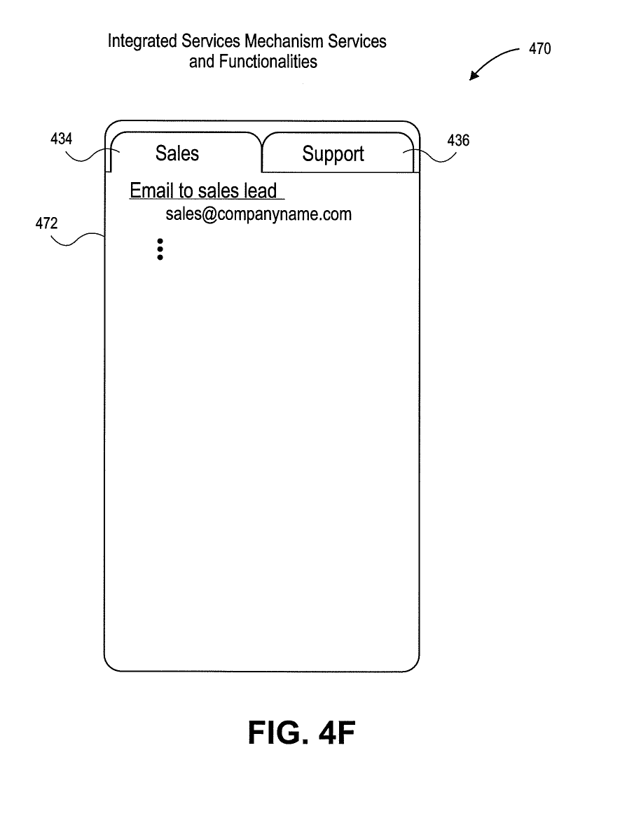

FIGS. 4A-4F illustrates screenshots 400, 410, 430, 450, 460, 470 representing various processes for facilitating integration of CRM services and non-CRM services via an integrated services mechanism according to one embodiment. FIG. 4A illustrates a screenshot 400 representing a user login or signup page 402 for logging-in or singing-up to access and use the integrated mechanism. The login/signup page 402 provides a login option 404 for an existing user to provide a username and password to login into the integrated mechanism and a signup option 406 for a new user to sign-up for the integrated mechanism-based services. It is contemplated that the integrated mechanism may be given any one or more brand names for identification and/or marketing. In one embodiment, the integrated mechanism may be a mobile integrated mechanism installed on a mobile (client) computing device, while the non-integrated, non-mobile CRM mechanism may be provided by a fixed (server) computing device.

The sign-up screen or option 406 is further illustrated in screenshot 410 of FIG. 4B. The sign-up option 406 may request a new user to provide some information such as, but not limited to, email 414, company or business name 416, (new) password 418, etc., and click sign up 420 to sign-up or register to use the integrated mechanism. For example, for future transactions, the email 414 may be used as a username along with the password 418 for the user to gain access to the integrated mechanism. In one embodiment, the sign-up option 406 may assume that the user's company or domain has not been used to create a user account, and that the user is signing-up (for the first time) to begin using the integrated mechanism. In another embodiment, the user's company may already be a subscriber to the integrated mechanism, and the user may be signing-up (as a returning user) to gain access to the features and services provided by the integrated mechanism and/or as selected or configured by the user's company. It is contemplated that other authentication credentials may be requested and that the illustrated credential requests 414-418 are merely shown as examples for brevity, clarity, and ease of understanding and are not meant as limitations.

FIG. 4C illustrates a screenshot 430 representing an integrated mechanism services and functionalities page 436 to provide the user with a set of default or pre-defined features as provided by the integrated mechanism and/or as configured or selected by the user's business organization. For example, as illustrated, the page 436 may be organized as tabs, such as a support tab 432 and a sales tab 434, to provide features or services relevant to, for example, identifying customer support (e.g., information regarding receiving and tracking customer issues, etc.) and sales (e.g., sales opportunities, sales closing deals, etc.), respectively. Certain features (e.g., email address 438, voicemail box 440, texting or SMS option 442, support page for a Uniform Resource Locator (URL) for a pre-designed webpage 444, social network websites 446, 448, and the like) may be automatically provided to a user upon signing into the integrated mechanism.

These illustrated features may be set up for the user upon sign-up, providing dedicated conduits for receiving CRM and non-CRM services. For example, as previously discussed, if a customer calls the voicemail box number, the voicemail message may be transcribed, in real-time or near-time, into a text message to be made available to the user as illustrated in screenshot 432 of FIG. 4D. Here, a customer leaves a voicemail message using the number assigned to the user. The voicemail message may be automatically linked to a “case” 452 and consequently, creating a traceable record of a support call made by a customer, and any subsequent actions taken to address the support call. Other information related to the support call, such as the caller's contact information 454, information about a relevant product or service, or the prior support call history involving the caller, may be associated and accessible to the user through the integrated mechanism on the user's computing device. As illustrated in FIG. 4D, a small preview 454 of the transcribed voicemail message may be made available to the user. Clicking, touching, tapping, or otherwise selecting the voicemail text message 454 may lead to an expanded screen with a complete text 462 of the transcribed message as illustrated in screenshot 460 of FIG. 4E. Conversely, a text or email message may be transcribed into sound, such as a voicemail message.

Case details page 452 depicts various actions or options 464, 466, 468 for annotating the transcribed voicemail message 462 with any related information. The options include updating the case 464 (based on the message 462), listening to the original voicemail message 466, calling back the customer (who left the voicemail message) 468, and the like. It is contemplated that the integrated mechanism can incorporate and provide any number of options for, for example, following up, annotating, argumenting the information provided in the integrated mechanism, etc., and that embodiments of the invention are not limited to the illustrated options 464, 466, 468. Furthermore, various similar or different options may be provided for sales 434 and support 436 and any other CRM or non-CRM service provided by the integrated mechanism. For example, upon sign-up, the user may be assigned an email address 472 for receiving sales leads or opportunities within the sales tab 434 as illustrated in screenshot 470 of FIG. 4F. The integrated mechanism may have a portion of or additional fields for tracking potential sales leads.

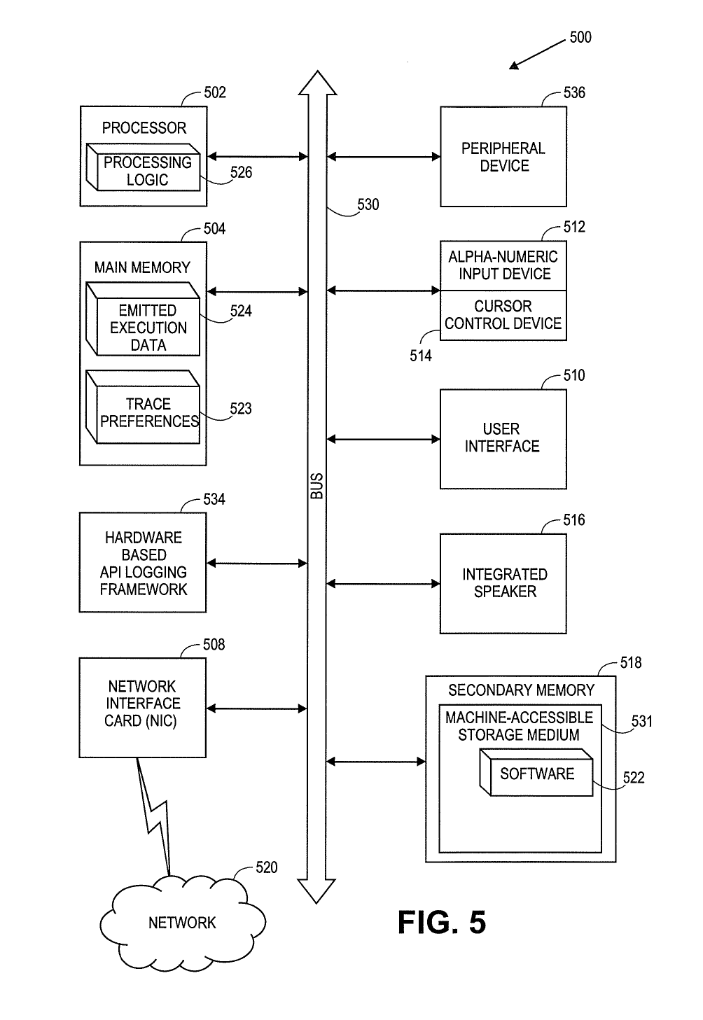

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of integrated services mechanism 108 as described with reference to FIGS. 1 and 2 and other figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a non-transitory machine-readable storage medium (or more specifically a machine-accessible storage medium) 531 on which is stored one or more sets of instructions (e.g., software 522) embodying any one or more of the methodologies or functions of integrated services mechanism 108 as described with reference to FIGS. 1 and 2 and other figures described herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508.

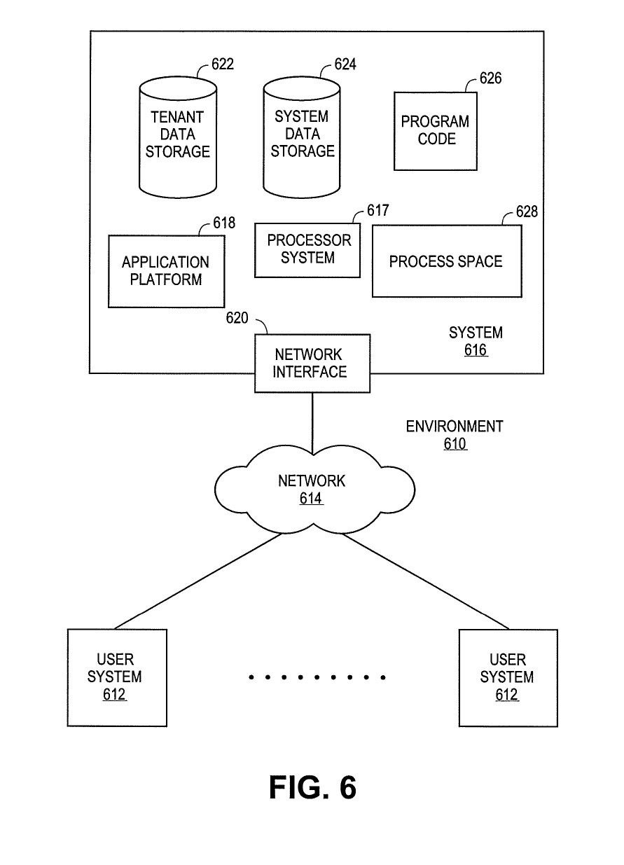

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

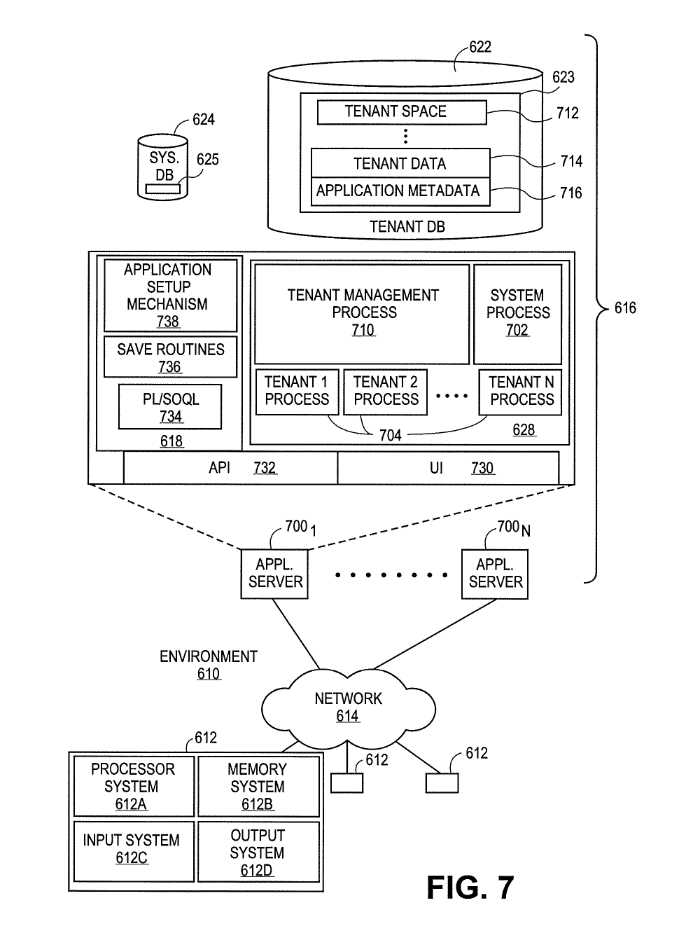

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users’ data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A computer-implemented method comprising:
integrating customer relationship management (CRM) modules to provide access to CRM services with non-CRM modules to provide access to non-CRM services into a single integrated mechanism, wherein the integrated mechanism is employed at a first computing system;
processing a user request for one or more services, wherein the one or more services include one or more CRM services or one or more non-CRM services; and
providing access to the one or more services via the integrated mechanism at the first computing system.

2. The computer-implemented method of claim 1, wherein the user request is received at the first computing system from a user accessing the integrated mechanism at the first computing system.

3. The computer-implemented method of claim 1, further comprising accessing the one or more service at a second computing system via an access portal provided by the integrated mechanism at the first computing system, wherein the first computing system includes a client computing system, and wherein the second computing system includes a server computing system coupled to the first computing system over a network including the Internet.

4. The computer-implemented method of claim 3, wherein the client computing system comprises a mobile computing system including a smartphone, a handheld computing device, or a tablet computing device.

5. The computer-implemented method of claim 1, further comprising generating a user profile via the integrated mechanism at the first computing system, wherein the user profile is authorized at the second computing system prior to providing access to the one or more services.

6. The computer-implemented method of claim 1, further comprising displaying, at the first computing system, information relevant to the one or more services.

7. A non-transitory machine-readable medium carrying one or more sequences of instructions which when executed by one or more processors, cause the one or more processors to carry out the steps of:
integrating customer relationship management (CRM) modules to provide access to CRM services with non-CRM modules to provide access to non-CRM services into a single integrated mechanism, wherein the integrated mechanism is employed at a first computing system;
processing a user request for one or more services, wherein the one or more services include one or more CRM services or one or more non-CRM services; and
providing access to the one or more services via the integrated mechanism at the first computing system.

8. The non-transitory machine-readable medium of claim 7, wherein the user request is received at the first computing system from a user accessing the integrated mechanism at the first computing system.

9. The non-transitory machine-readable medium of claim 7, wherein the one or more processors further carry out the step of accessing the one or more service at a second computing system via an access portal provided by the integrated mechanism at the first computing system, wherein the first computing system includes a client computing system, and wherein the second computing system includes a server computing system coupled to the first computing system over a network including the Internet.

10. The non-transitory machine-readable medium of claim 9, wherein the client computing system comprises a mobile computing system including a smartphone, a handheld computing device, or a tablet computing device.

11. The non-transitory machine-readable medium of claim 7, wherein the one or more processors further carry out the step of displaying, at the first computing system, information relevant to the one or more services.

12. The non-transitory machine-readable medium of claim 7, wherein the server computing system is coupled to the client computing system over a network, the network including the Internet.

13. A system comprising:
a processor; and
one or more stored sequences of instructions which, when executed by the processor, cause the processor to carry out the steps of:
integrating customer relationship management (CRM) modules to provide access to CRM services with non-CRM modules to provide access to non-CRM services into a single integrated mechanism, wherein the integrated mechanism is employed at a first computing system;
processing a user request for one or more services, wherein the one or more services include one or more CRM services or one or more non-CRM services; and
providing access to the one or more services via the integrated mechanism at the first computing system.

14. The system of claim 13, wherein the user request is received at the first computing system from a user accessing the integrated mechanism at the first computing system.

15. The system of claim 13, wherein the processor to further carry out the step of accessing the one or more service at a second computing system via an access portal provided by the integrated mechanism at the first computing system, wherein the first computing system includes a client computing system, and wherein the second computing system includes a server computing system coupled to the first computing system over a network including the Internet.

16. The system of claim 15, wherein the client computing system comprises a mobile computing system including a smartphone, a handheld computing device, or a tablet computing device.

17. The system of claim 13, wherein the processor to further carry out the steps of displaying, at the first computing system, information relevant to the one or more services.

18. The system of claim 13, wherein the server computing system is coupled to the client computing system over a network, the network including the Internet.
